(19) United States
(12) Patent Application Publication
(10) Pub. No.: US 2005/0125293 A1
(43) Pub. Date: Jun. 9, 2005

(54) Order automation system improvement

(76) Inventors: Gabriel A Germinara, Sao Paulo (BR); Ernest D Freiberg, Buenos Aires (AR); Walter D Huarriz, Buenos Aires (AR)

Correspondence Address: Joel N Bock;Sills Cummis Epstein & Gross, One Riverfront Plaza, Newark, NJ, 07102-5400, US

(21) Appl. No.: 10/499,076

(22) PCT Filed: Dec. 10, 2002
(86) PCT No.: PCT/BR02/00181

(30) Foreign Application Priority Data
Dec. 10, 2001 (BR) PI0106297-2

(51) Int. Cl. G06F 17/60

(52) U.S. Cl. 705/15

(57) ABSTRACT

An order automation system improvement is provided for use in restaurants and akin, which offers special attention to operating the table saloon or waiting lines, by taking orders on electronic forms, based on portable computers type Pocket PC, with LCD coloured screen type touch screen and radio frequency wireless communication. The wireless communication eliminates the going and coming of the waiters to and from the kitchen and pantry to deliver and get the orders. The system makes it possible to encourage, without being ostensive, the consumption of higher margin items and the attention to new requests from the clients.

The present invention belongs to the operational automation system field applied in food establishments; more specifically, it refers to the improvement of operational automation systems used in restaurants and akin, based on taking orders on electronic forms that use portable computers, through the utilization of on line radio frequency communication.

The use of electronic automation systems at restaurants, with the objective of shortening the time of the orders between the clients and the kitchen, has been tried out, in that activity field, due to its potential of improving the rendering of services and to the increase of productivity that, in thesis, it could offer.

Several types of systems have been proposed, however, the technical effects of the improvement herein put forward have not been attained.

In the present state of art, the waiters of the most restaurants take the orders from the clients manually, using blocks of paper and a pen, then, going up to the production areas (that include the kitchen, bar, pantry, etc).

There are few restaurants that are already in some way automated. And those that are already automated have tried to reduce the walking of the waiters, by creating “extensions”, by means of terminals installed in set positions within the saloon, where the orders taken are transcribed to a system that will then transmit them to the corresponding production areas.

However, the systems with set terminals in the saloon and that used order forms on blocks of paper do not solve the problem of transcription errors.

The more sophisticated restaurants, which represent a minute portion among those already automated, provide the waiter with some type of portable apparatus, such as a wireless scanner, a RF data collector, etc.

Although the latter are already offering a certain advance regarding service quality, allowing to make the orders at the origin, at the tables or at the waiting lines without further transcriptions, they still depend of the memorization of product codes or carry a kind of barcode menu, which will be read by those apparatus that, in turn, must have proper scanners.

Even certain internationally known solutions, which use dedicated hardware manufactured for this purpose, have not been successful, either because of the size of the devices used, or because of faults in the construction of the interface screens with the waiters.

It is what occurs, for example, when the system's “navigation”, during the taking of orders, requires the opening of multiple windows in the portable computer, making the system very difficult both to understand and handle.

Other issues not yet solved are related also to the use of hardware and tools that are not adequate for developing the software, making the processing and, consequently, the service, very slow.

The data transmission technology by infrared rays has also been used in some systems. But do not have the same performance as RF communication, since they require a ‘direct view’ between the order forms and the transceptor station.

The ORDER AUTOMATION SYSTEM IMPROVEMENT, object of the present invention, comes to solve all those deficiencies, shown by the existing systems, presently integrated to the state of art, offering a new and inventive solution, by applying the most modern computer hardware and software technologies available and by creating a unique system in its area.

Thus, one of the objectives of the present invention is to provide an ORDER AUTOMATION SYSTEM IMPROVEMENT capable of speeding up the taking of orders at restaurants and akin.

It is also an objective of the present invention to offer a system capable of decreasing or eliminating the errors in the handwritten orders.

Another objective of the present invention is to keep the waiters (who actually are salespeople) in the saloon of the sales area, as he/she does not walk anymore to the kitchen or bar to hand in the orders and, afterwards, the deliveries are carried out at the tables or waiting lines by other professionals (attendants, busboys or delivery persons).

Another objective of the present invention is to encourage the consumption of the higher margin products.

Yet another objective of the present invention is to make the waiters more available to receive calls from the table or waiting line areas.

Finally, it is an objective of the present invention to speed up the closing and paying bill procedures.

### GENERAL DESCRIPTION OF THE INVENTION

The ORDER AUTOMATION SYSTEM IMPROVEMENT, object of the present invention is comprised, basically, by a compatible PC microcomputer connected to a hub/switch that, in turn, is connected to a wireless access point, connected to an Ethernet cabled network and to a printing server that, in turn, is connected to a series ticket issuing printers; the system is completed by a set of terminals, which are portable palm-top type computers and that transmit, in radio-frequency, proper signals to the access connection point to the cabled network.

The potable computers, used by the attendants, simulate electronic order forms, specially prepared and previously programmed, which allow to choose items among those shown on their screens in a natural language, by using fingertips, a pencil or a pen, as well as allowing to choose the clients' preferences, confirm the orders, request bills etc.

Thus, according to one of the aspects of the invention, an automation system for the operation of restaurants and akin is provided, which gives special attention to the operation in the table saloon or waiting lines, through taking orders on electronic forms, based on portable Pocket PC type computers, with coloured LCD touch screen and wireless communication by radio frequency.

In an embodiment of the invention, the ORDER AUTOMATION SYSTEM IMPROVEMENT, herein proposed, is comprised of, as hardware, a Pocket PC, in particular, the Compaq i-PAQ TANGO Pocket 3650 color, with Expansion Pack, Wireless PCMCIA (IEEE 802.11-DSSS/2,4 Ghz, Hi Rate (11 Mbp)s, which uses the Microsoft Win CE operational system; and as appliance software, uses the touch screen feature, with the fingertip or stylus pen, sole window to choose products and groups of products, the products being at the top of the screen and the groups of products at the bottom, divided into good sized cells, with side scrolling (← left & right →).

The bottom bar has inclusion options, such as the “preferences” (over done, medium, w/ice and orange) and “valet parking”.

Thus, using the natural characteristics present in the Hand Held i-Paq Pocket Compaq, which are light weight, reduced size, Win CE, powerful processor, LCD Color and accessories for Wireless RF communication, a product dedicated to the automation of taking orders at the gastronomic establishments, was developed.

Wireless communication eliminates the going and coming of the waiters to and from the kitchen and pantry to deliver or get the orders.

The immediate result is the full availability of that professional for the most important task, which is good service.

Another positive collateral effect of the waiters' presence in the sales saloon area is the possibility of encouraging, without being ostensive, the consumption of higher margin items and the increase of attending to new requests made by the clients.

The response time to the request of closing bills is also drastically reduced, which satisfies the clients and frees tables for the next clients.

The intensive exploitation of the ‘threesome’ Win CE/Powerful processor/LCD Colour made it possible to create interface screens with unprecedented format and exposition manner, focusing on easy comprehension and system operation, with a drastic reduction of errors when entering data and transferring information (caused either by only using the traditional paper order forms or by the transcription in fixed terminals).

The local network architecture is cabled (10/100 Mbps) and/or Wireless (11 Mbps) Ethernet TCP/IP.

The system's configuration, in its preferred embodiment, is comprised by:
a) a Pentium III server with 866 Mhz, 128M RAM, CD ROM, HD of 10 GB, 15″ Colour Monitor, RJ 45;
b) PC for the 500 Mhz Celeron box, 128M RAM, CD ROM, HD of 10 GB, 15″ Colour Monitor, RJ 45;
c) Hub;
d) UAP (Universal Access Point) Access Points, Wireless Hub, IEEE-802.11-2.4 Ghz-Hi, 11 Mbps;
e) Thermal Printers for the saloon and production areas (pre-bill);
f) RJ 45 Printing Servers, Ethernet Port, Parallel Port;
g) i-PAQ Tango: Compaq Color Pocket PC 3650 Series TangoSW embedded, WinCE-Wireless Application System, Compaq Expansion Pack, Wireless PCMCIA IEEE-802.11-2.4 Ghz-Hi 11 Mbps

The system allows the cabled connection in Ethernet network environment, of ticket issuing printers that, typically, only have parallel, serial or USB interfaces.

Ticket issuing printers of 40 columns by matricial or thermal printing process (recommended). The ticket printers (for production and pre-bills) must have an automatic paper-cutting device (guillotine) with partial cutting.

For electronic order forms, Pocket PC portable computers on Microsoft Windows CE (v3.0 or greater) platform, with LCD Colour TFT Display (active matrix) or similar, Touch Screen, RAM Memory of at least 32 MB, RISC Processor of 200 Mhz or greater, and Wireless Local Network communication interface (WLAN), according to standard IEEE 802.11 (2.4 Ghz; 11 Mbps) or greater, are used.

### BRIEF DESCRIPTION OF THE DRAWINGS

FIG. 1 shows a possible sketch of the ORDER AUTOMATION SYSTEM IMPROVEMENT, according to one of the embodiments of the present invention.

FIG. 2 shows a screen to make orders, according to the system's operational procedure, according to one of the embodiments of the present invention.

FIG. 3 shows a flowchart representing the steps of an order operation.

### DETAILED DESCRIPTION OF THE PREFERRED EMBODIMENT

The present invention, for a better understanding, will be described referring to the figures attached. The present invention, however, is not limited to the system detailed below, but is applicable to several similar systems, which have the characteristics claimed in this report.

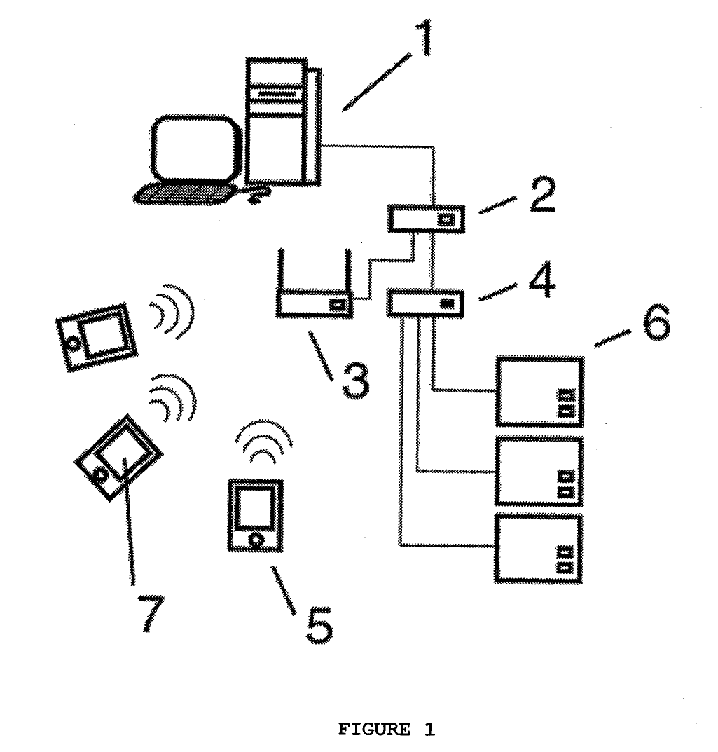

FIG. 1 shows a block functional diagram, illustrating the configuration of the ORDER AUTOMATION SYSTEM IMPROVEMENT, according with an preferred embodiment of the present invention.

According to one of the aspects of the present invention, the ORDER AUTOMATION SYSTEM IMPROVEMENT is capable of speeding up the taking of orders at restaurants and akin.

According to another aspect of the present invention, the system is capable of diminishing or eliminating the errors in the handwritten transcription of the orders.

According to yet another aspect of the present invention, the system proposed keeps the waiters in the saloon of the sales area, as he/she does not walk anymore to the kitchen or bar to hand in the orders and, afterwards, the deliveries are carried out at the tables or waiting lines by other professionals (attendants, busboys or delivery persons).

According to yet another aspect of the present invention, the consumption of higher margin products is encouraged.

According to yet another aspect of the present invention, a greater availability of the waiters is made possible to attend to the requests in the table area or waiting lines.

Finally, According to yet another aspect of the present invention, the closing and paying bill procedures are speeded up.

As illustrated in FIG. 1, in a minimum configuration, a compatible PC microcomputer (1) is connected to a hub/switch (2) that, in turn, is connected to a wireless Access Point (3), connected to an Ethernet cabled network and to a printing server (4), in turn, connected to a series of ticket issuing printers (6). The system is completed by a set of terminals, which can be palm-top type portable computers (5), which transmit, in radio frequency, the proper signals to the access point (3) connecting to the cabled network.

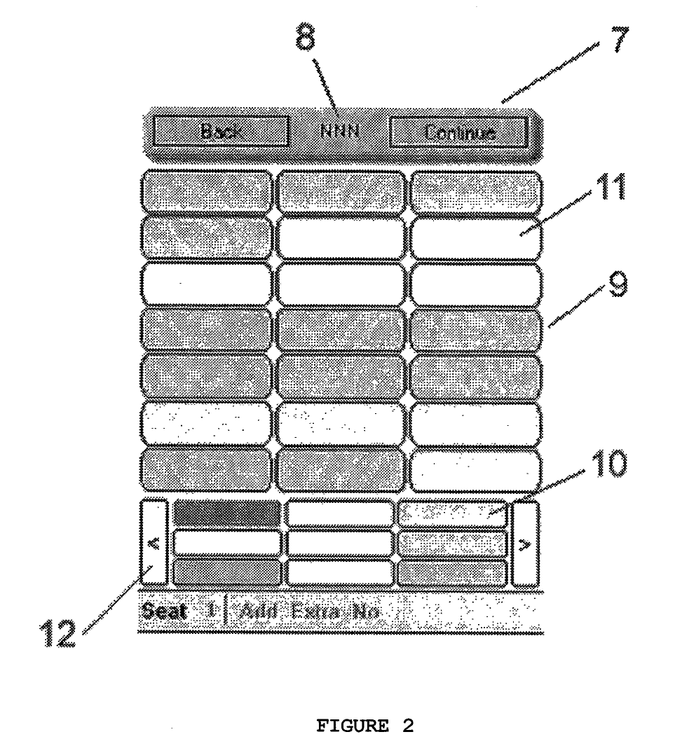

The several portable computers (5), used by each attendant, simulate electronic order forms, previously programmed, as shown in FIG. 2, making it possible to choose items among those displayed on their screens (7), with a pencil, allowing to choose the preferences of the clients, confirm orders etc.

The system, within a maximum of three seconds, will register the order taken down by the attendant on a screen of a terminal (5), and will issue a order form in the production sector, which can be the kitchen, the bar, the pizza parlour etc., depending on the choice.

O terminal (5) also allows the attendant to make other transactions, such as transferring tables, closing bills, cancelling requests etc.

FIG. 2 is a screen to make orders, according to the systems operational procedure, in conformity with one of the embodiments of the present invention.

The ORDER AUTOMATION SYSTEM IMPROVEMENT, object of the present invention, has an application software for taking orders, specially developed that, in one of the embodiments, it uses the IPAQ computer series 3600, with a mobile touch screen.

The ORDER AUTOMATION SYSTEM IMPROVEMENT, herein proposed, includes, in one of its preferred embodiments, as hardware, a Pocket PC, which is comprised by a standard hardware with worldwide support and technical service, the Compaq i-PAQ TANGO Pocket 3650 colour, with Expansion Pack, Wireless PCMCIA IEEE 802.11-DSSS 2.4 GHz, Hi Rate (11 Mbp), which uses the Microsoft WinCE operational system.

The application software uses the touch screen device, using fingertips or a stylus pen, sole window (7) to choose products (9) and/or groups of products (10), the products located at the top of the screen and the groups of products at the bottom, divided in proper sized cells (11), with side scrolling (12) (← left and right →).

The bottom bar has inclusion options, such as “preferences” (over done, medium, w/ice+orange etc.) and “valet parking”.

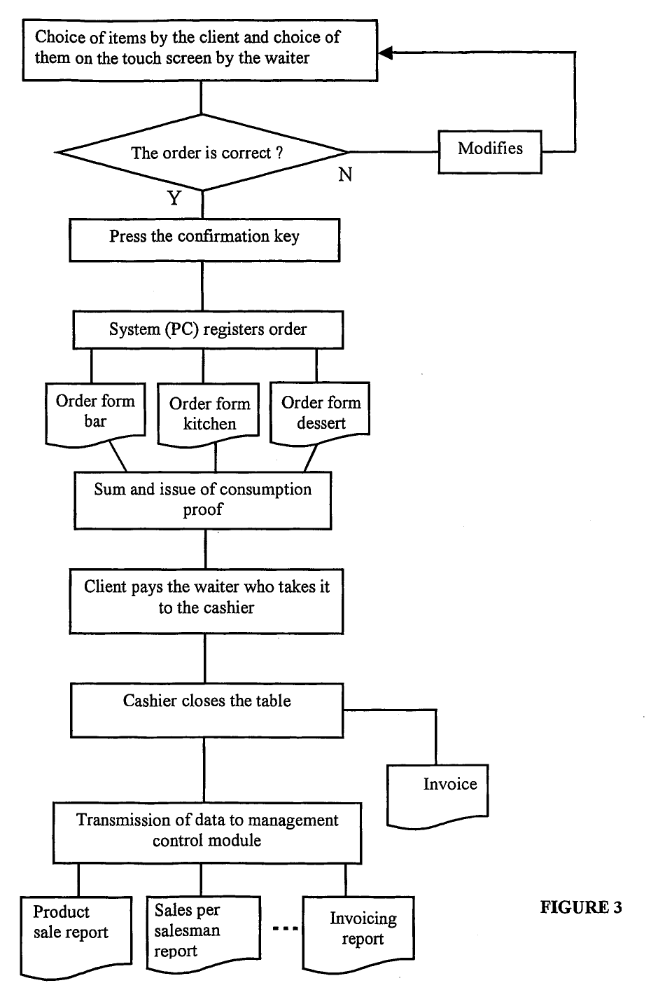

Below the steps of the use of the ORDER AUTOMATION SYSTEM IMPROVEMENT, are described, as represented by the flowchart of FIG. 3.

In a first step, the client makes his order at the table (8), and the attendant (or waiter) chooses the items on the display of the Pocket PC, as well as his preferences.

In a second step, as soon as the items are included in the order form (7), the order is completed by choosing a confirmation key.

In a third step, in the event of an error or cancellation of an item, it can be eliminated or modified, immediately, within a maximum of 3 seconds.

In a third step, the system will register the order and issue an order form, at the production sector (kitchen, bar, pizza, etc.), depending on the product.

In a fifth step, other transactions such, for example, transferring tables, cancelling products, closing bills, can also be performed, such operations can be restricted, depending on a management password.

For greater security, the waiter can request the statement for any table, in which all the items, ordered up to that time, can be seen.

In the bill closing step, the client asks the waiter for his bill who, in turn, issues a consumption proof in the printer established for that table and hands it to the client.

In the payment step, once he has been received from the client, the waiter goes to the cash register.

In the closing step, the cashier types the number of the table (8) and specifies the form of payment (cash, credit card, voucher, etc.) registering, in this way, the closure of the table.

If the system is configured to operate with a fiscal printer, a proof form will be issued at the time of closure and handed to the client.

The job of the cashier is totally reduced as he does not need to enter the consumed products anymore, simply receive the payment, which significantly increases his administration capacity.

For information and management control, the system has a management control module, where all the cancellation, transfer, discount, etc. operations can be consulted, carried out by the supervisor, identifying time, values, etc. of each transaction.

This option gathers together the functions of issuing statistical reports, useful for the management of the establishment, such as sold product reports, sales by salesman, invoicing, etc.

The system has configuration options that makes it easier to adapt to any type of establishment, such as sales per unit, per kilo, per litre etc., happy hour sales, offers, connection too fiscal printers, multiple cash registers etc.

The operational environment is satisfactory, with all the options shown on the display, not being necessary to type codes, there is also a great speed in loading data, using a simple language, etc., and help on line in each mode.

1) ORDER AUTOMATION SYSTEM IMPROVEMENT for use in gastronomic establishments, characterized by that orders are taken by means of mobile hand terminals, which simulate electronic order forms, with options shown in a natural language and/or simulate note messages free handwritten by the attendants, based on pocket PC type portable computers with LCD touch screen and communication by radio frequency.

2) ORDER AUTOMATION SYSTEM IMPROVEMENT for use in gastronomic establishments, according to claim 1, also characterized by that the portable computers which comprise the system simulate electronic order forms previously programmed, making it possible to choose, by touch, items shown on their screen in natural language, among which are the clients' preferences.

3) ORDER AUTOMATION SYSTEM IMPROVEMENT for use in gastronomic establishments, according to claims 1 and 2, characterized by that the said system registers the order written by the attendant on said screen of said terminal, within less than three seconds.

4) ORDER AUTOMATION SYSTEM IMPROVEMENT for use in gastronomic establishments, according to claims 1, 2 and 3, characterized by comprising the integration of a hand computer of the pocket PC type or equivalent, of wireless communication, with a proper embedded operational system.

5) ORDER AUTOMATION SYSTEM IMPROVEMENT for use in gastronomic establishments, according to claims 1, 2 and 3, also characterized by comprising an application software for taking orders, which uses a touch screen device, using fingertips or a stylus type pen, sole window for choosing products and/or groups of products.

6) ORDER AUTOMATION SYSTEM IMPROVEMENT for use in gastronomic establishments, according to claim 5, characterized by comprising application software, which uses the computer type pocket PC, or equivalent, with touch screen.

7) ORDER AUTOMATION SYSTEM IMPROVEMENT for use in gastronomic establishments, according to claim 6, characterized by comprising a window in which the products are located at the top of the screen and the groups of products at the bottom of it, divided in proper sized cells, with side scrolling.

8) ORDER AUTOMATION SYSTEM IMPROVEMENT for use in gastronomic establishments, according to the previous claim, characterized by the said window comprising a lower bar with inclusion options of preferences or other services.

9) ORDER AUTOMATION SYSTEM IMPROVEMENT for use in gastronomic establishments, according to claims 1 and 2, characterized by said system comprising one or more computers of the pocket PC type or equivalent and accessories for RF wireless communication or equivalent.

10) ORDER AUTOMATION SYSTEM IMPROVEMENT for use in gastronomic establishments, according to previous claims, characterized by the system's configuration comprising:
server type PC or equivalent;
Hub/Switch or equivalent;
Access Points of the type Universal Access Point or equivalent;
Printers or Monitors for the saloon and production areas or equivalent.
